(19) United States
(12) Patent Application Publication
(10) Pub. No.: US 2009/0153704 A1
(43) Pub. Date: Jun. 18, 2009

(54) RECORDING AND REPRODUCTION APPARATUS AND METHODS, AND A STORAGE MEDIUM HAVING RECORDED THEREON COMPUTER PROGRAM TO PERFORM THE METHODS

(75) Inventor: Mineki Taoka, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/327,013

(22) Filed: Dec. 3, 2008

(30) Foreign Application Priority Data
Dec. 14, 2007 (JP) 2007-323929

(51) Int. Cl. H04N 5/262

(52) U.S. Cl. 348/240.2; 348/E05.055

(57) ABSTRACT

Recording and reproduction apparatus, recording and reproduction methods, and a storage medium storing a computer program to execute the methods to retain magnification information regarding digital zoom manipulation during capturing of an image, prevent decrease in image quality of recorded images, and reproduce high-quality images with digital zoom. The recording apparatus includes an image processor for processing raw data, sequentially output from an imaging device in frames, into reproducible image data and generating processed image data in frames, a magnification information obtaining unit for obtaining magnification information, which is information regarding magnification process performed during the image processes, and a storage medium recorder sequentially recording the raw data in frames, the processed image data in frames, and the magnification information in frames to a storage medium per frame.

### CROSS-REFERENCE TO RELATED PATENT APPLICATION

This application claims the benefit of Japanese Patent Application No. 2007-323929, filed on Dec. 14, 2007, in the Japanese Intellectual Property Office, the entire contents of which is incorporated herein by reference.

### BACKGROUND OF THE INVENTION

1. Field of the Invention

The present invention relates to recording and reproduction apparatus, recording and reproduction methods, and a storage medium having recorded thereon a computer program to perform the methods.

2. Description of the Related Art:

Generally, an image capturing device capable of recording motion pictures, such as a video camera, camcorder, etc., performs predetermined image processing (image signal processing) on signals output from each of pixels of an imaging device such as a charge-coupled device (CCD), performs compression in a format such as the motion picture experts group (MPEG)-2, the motion joint photographic experts group (JPEG), etc., and records image data to a storage medium such as a flash memory, a hard disk drive (HDD), or a digital versatile disc (DVD). Image processing may include white balance control, exposure control, etc. Also, if images are recorded with digital zoom, a zoomed image is obtained by cropping and extracting data from part of an imaging device and magnifying the cropped and extracted data. For example, Japanese Patent Publication No. 2004-214985 discloses a technique to preserve a region which is discarded by performing compressive encoding with a different compression ratio from a region cropped and extracted for digital zoom.

Generally, as compression is performed after image processing, quality of images recorded or reproduced decreases as compared to that of images prior to compression. Therefore, certain image capturing devices which record a still image, such as digital cameras, record signals output from imaging device in the raw format without compression. However, data quantity to be processed increases when motion pictures are recorded in the raw format in an image capturing device such as a camcorder. Thus, it is common to preserve and use reduced images for operations, such as image signal processing, or reproduction in an image capturing device.

As stated above, since data is cropped and extracted from only a part of an imaging device in a case where images are recorded with digital zoom, data quantity decreases as compared to a case where digital zoom processing is not performed. Furthermore, quality of reproduced images decreases, because magnifying processing is performed on cropped and extracted data.

### SUMMARY OF THE INVENTION

The present invention provides new and improved recording and reproduction apparatus, recording and reproduction methods, and a storage medium having recorded thereon a computer program to execute the methods in order to retain magnification information regarding digital zoom manipulation during capturing of an image, prevent decrease in image quality of recorded images, and reproduce high-quality images with digital zoom.

Accordingly, an embodiment of the present invention provides a recording apparatus comprising an image processor for processing raw data sequentially output from an imaging device in frames into reproducible image data and generating processed image data in frames, a magnification information obtaining unit for obtaining magnification information, which is information regarding a magnification process performed during the image processing, and a storage medium recorder for sequentially recording the raw data in frames, the processed image data in frames, and the magnification information in frames to a storage medium per frame. The magnification information may be power data.

Another embodiment of the present invention provides a reproduction apparatus comprising a data reader for reading at least one of each of raw data, each of processed image data, and each of magnification information from a storage medium having recorded thereon the raw data in frames, with the processed image data in frames having been obtained by processing the raw data into reproducible image data , and the magnification information regarding digital zoom manipulation performed during recording the processed image data. The reproduction apparatus further comprises an image processor for performing an image process which partially magnifies corresponding raw data in a frame according to the read magnification information when the raw data is sequentially reproduced per frame.

A further embodiment of the present invention provides a recording method comprising processing raw data, sequentially output from an imaging device in frames, into reproducible image data and generating processed image data in frames, obtaining magnification information, which is information regarding magnification process performed during the image processes, and sequentially recording the raw data in frames, the processed image data in frames, and the magnification information in frames to a storage medium.

A further embodiment of the present invention provides a reproducing method comprising reading at least one of each of raw data, each of processed image data, and each of magnification information from a storage medium having recorded thereon the raw data in frames, with the processed image data in frames having been obtained by processing the raw data into reproducible image data, and the magnification information regarding digital zoom manipulation performed during recording the processed image data, and performing an image process which partially magnifies corresponding raw data in a frame according to the read-out magnification information when the raw data is sequentially reproduced per frame.

Another embodiment of the present invention provides a storage medium having recorded thereon a computer program for executing a method comprising processing raw data into reproducible image data, sequentially output from an imaging device in frames, and generating processed image data in frames, obtaining magnification information, which is information regarding magnification process performed during the image processes, and sequentially recording the raw data in frames, the processed image data in frames, and the magnification information in frames to a storage medium. Still another embodiment of the present invention provides a storage medium having recorded thereon a computer program for executing a method comprising reading out at least one of each of raw data, each of processed image data, and each of magnification information from a storage medium to which the raw data has been recorded in frames, the processed image data in frames having been obtained by processing the raw data into reproducible image data, and the magnification information regarding digital zoom manipulation performed during recording the processed image data. The method further comprises performing an image process partially magnifying corresponding raw data in a frame according to the read-out magnification information when the raw data is sequentially reproduced per frame.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an example of a configuration of a motion picture recording apparatus according to an embodiment of the present invention;

FIGS. 2(a) and 2(b) are schematic diagrams illustrating an example of a recording format in which the motion picture recording apparatus records a motion picture to a storage medium;

FIG. 3 is a schematic diagram of an example of an image capturing surface of an imaging device according to the embodiment of FIG. 1; and

FIG. 4 is a block diagram illustrating an example of a configuration of the motion picture reproduction apparatus according to the embodiment of FIG. 1.

### DETAILED DESCRIPTION OF THE EMBODIMENTS

Exemplary embodiments of the present invention will now be described more fully with reference to the attached drawings. Like reference numerals in the drawings denote like elements, and thus their description will be omitted.

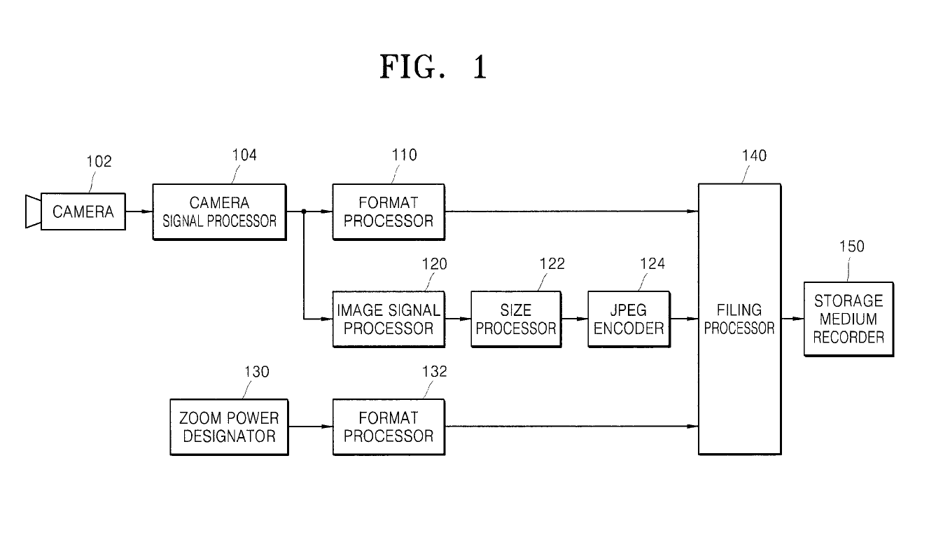

FIG. 1 is a block diagram illustrating an example of a motion picture recording apparatus 100 according to an embodiment of the present invention. The motion picture recording apparatus 100 in this example includes a camera 102, a camera signal processor 104, a format processor 110, an image signal processor 120, a size processor 122, a joint photographic experts group (JPEG) encoder 124, a zoom power designator 130, a format processor 132, a filing processor 140, and a storage medium recorder 150. Motion picture data per frame output from an imaging device, such as a charge-coupled device (CCD), a complementary metal oxide semiconductor (CMOS), etc., of the camera 102, is input to the camera signal processor 104. The camera signal processor 104 includes an analog-to-digital (AD) converter converting an input signal from analog to digital. A digital image signal output from the camera signal processor 104 is transmitted to both the format processor 110 and the image signal processor 120.

The format processor 110 rearranges digital-converted red (R), green (G), and blue (B) signals according to a pixel arrangement (i.e., Bayer arrangement, triple CCD, etc.) of imaging device. Also, the format processor 110 performs reversible compression on motion picture data in a frame. Reversible compression method enables recording and reproducing image data without degradation in image quality, etc. An example of a reversible compression method is an entropy encoding using Huffman codes. Also, the reversible compression method is not limited to “reversible” in the strict sense. Accordingly, the format processor 110 does not perform compression, whereby image quality is lost, in order to maintain the image quality in raw data. Furthermore, since the size of raw data is very large, the format processor 110 eliminates most of unnecessary part from the raw data. Motion picture data formatted by the format processor 110 is input to the filing processor 140 as raw data.

The image signal processor 120 performs image signal processing on input image data, with the image signal processing including white balance processing, data interpolation processing according to, for example, the Bayer arrangement, noise elimination, brightness and color correction, etc. Data processed by the image signal processor 120 is transmitted to the size processor 122.

The size processor 122 performs a process to reduce the size of motion picture data. Here, in a case where digital zoom is used when capturing an image, the size processor 122 performs a digital zoom process, that is, cropping and extracting data from a part of a data region and magnifying the cropped and extracted data. Data output from the size processor 122 is transmitted to the JPEG encoder 124.

Furthermore, if necessary, the size processor 122 performs the process of reducing the size of motion picture data according to the screen size of display devices such as an electronic view finder (EVF) (not shown), a liquid crystal display (LCD) (not shown), etc. Data output from the size processor 122 is transmitted to a display device such as an EVF or a LCD and is displayed on the screen of the same. Thus, a user can recognized an image captured by the camera 102 in real time.

The JPEG encoder 124 performs JPEG compression coding process on input data and transmitted compressed image data (processed image data) to the filing processor 140. The zoom power designator 130 is an example of a unit for obtaining magnified data. The zoom power designator 130 obtains a power data corresponding to a scale factor of a digital zoom manipulated per frame when capturing a motion picture. Here, the power data is an example of magnified data which is data for a magnification process. The zoom power designator 130 transmits the power data to the format processor 132. The format processor 132 performs a format process on the power data, and transmits generated data to the filing processor 140. Power data below is data required for designating a part in a frame of raw data (a region of the original image) and performing magnification process thereon.

The filing processor 140 temporarily stores raw data transmitted from the format processor 110, compressed image data compressed in the JPEG encoder 124, or power data transmitted from the format processor 132. The raw data transmitted from the format processor 110, the compressed image data compressed in the JPEG encoder 124, and the power data transmitted from the format processor 132, stored in the filing processor 140, are transmitted to the storage medium recorder 150 and are recorded to a storage medium according to a recording format of the storage medium. Examples of the storage medium include optical recording media (CD, DVDs, etc.), magneto-optical disks, magnetic disks, semiconductor memory devices, etc.

Furthermore, although not shown, the motion picture recording apparatus 100 includes a host CPU. The host CPU controls data transmission from the filing processor 140 to the storage medium recorder 150 and data recording of the storage medium recorder 150 to a storage medium. The host CPU transmits compressed image data, raw data, and power data, stored in the filing processor 140, to the storage medium recorder 150 per predetermined quantity (i.e. data quantity of one frame) and controls the filing processor 140 and the storage medium recorder 150 such that the transmitted data are sequentially recorded to a storage medium. The host CPU records compressed image data, raw data, and power data to a storage medium in a predetermined sequence. Furthermore, processes in the motion picture recording apparatus 100 can be performed either by hardware or software.

In the motion picture recording apparatus 100 according to the current embodiment, digital image data output from the imaging device of the camera 102 and converted from analog to digital is transmitted to the format processor 110, and raw data is recorded to a storage medium. Therefore, high-quality raw data is recorded to a storage medium, and images having higher quality as compared to compressed image data can be reproduced by reading and displaying the raw data.

Meanwhile, since the size of raw data is very large, images cannot be displayed on a display device such as an EVF or a LCD in real time by using raw data. Furthermore, compression process such as JPEG compression cannot be performed directly on raw data. In the motion picture recording apparatus 100 according to this embodiment, since the image signal process, size reducing process, and compression process are performed together with raw data recording, images can be displayed on a display device such as an EVF or a LCD in real time as the images are captured. Thus, a user can capture images while monitoring displayed images. Furthermore, since compressed image data is recorded to a storage medium together with raw data, operations such as image browsing, thumbnail image displaying, etc., can be performed by using the compressed image data. Therefore, important part of images can be reproduced with high quality by using raw data, whereas relatively less important part of images can be reproduced in simplified form by quickly reading compressed image data.

Furthermore, the motion picture recording apparatus 100 according to this embodiment stores raw data intact and files power data corresponding to digital zoom level together with raw data. Since power data is recorded to a storage medium together with raw data, the image signal process can be performed on raw data by reading the power data, and thus high quality image signal process can be performed. Furthermore, compressed image data as reference images is digital zoomed data of which a quantity is reduced. Therefore, operations such as image browsing, image confirmation, etc., can be performed efficiently by using the compressed image data.

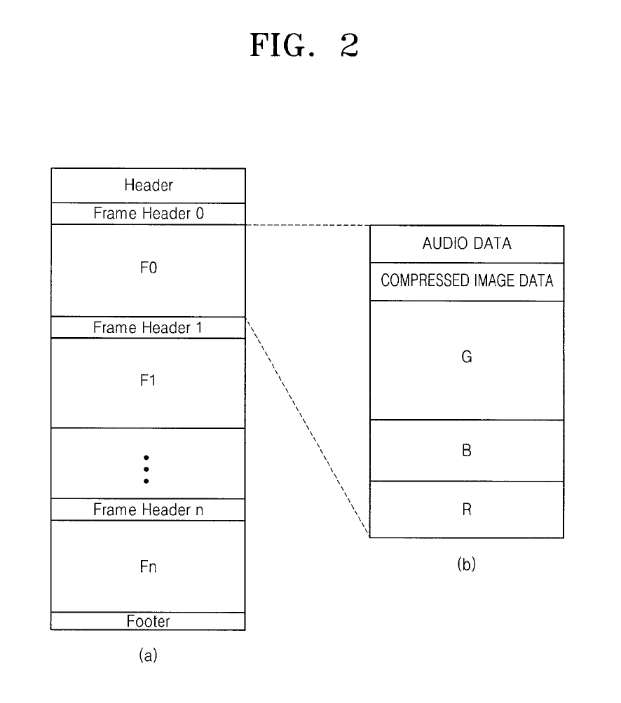

Next, an example of a recording format of a storage medium will be described. FIGS. 2(a) and 2(b) are schematic diagrams illustrating an examples of a recording format in which the motion picture recording apparatus 100 records data to a storage medium. For example, if only one Bayer imaging device is used, data is output in a pixel sequence of the Bayer arrangement of R:G:B=1:2:1. To record the data in the Bayer arrangement without loss of image quality, the data is rearranged in a sequence of RGB by the format processor 110 and the rearranged data is recorded to a storage medium without performing a compression process, which degrades image quality, in the motion picture recording apparatus 100.

FIG. 2(a) indicates a single motion picture file between the start of image recording (record start) and the end of image recording (record end). Furthermore, FIG. 2(b) indicates data of one frame in recorded data shown in FIG. 2(a).

RGB data according to the Bayer arrangement is rearranged by the format processor 110 and is recorded to a data region of a storage medium. Furthermore, compressed image data encoded by the JPEG encoder 124 and audio data formatted in a format processor not shown are also recorded to the data region. As shown in FIG. 2(a), a header is recorded to a first region of a recording format. General data including the date when an image is captured, information on an imaging device of the camera 102, a set name of the motion picture recording apparatus 100, the number of audio channels, the number of bits, information on a recording format of a storage medium, spec data of a lens of the camera 102, etc., are recorded to the header. After the header, data is recorded per frame of images.

Data per frame includes frame headers Frame Header 0 through Frame Header n and data per frame F0 through Fn. As shown in FIG. 2(b), data per frame are recorded repeatedly per frame in a sequence of audio data Audio, compressed image data Compressed Image, and raw data G, B, and R. Then, a footer is recorded following to data of final frame Fn.

For example, the sizes of audio data, compressed image data, and raw data of each frame are recorded to a frame header of each of the frames. Furthermore, power data for each of the frames are recorded to the frame headers.

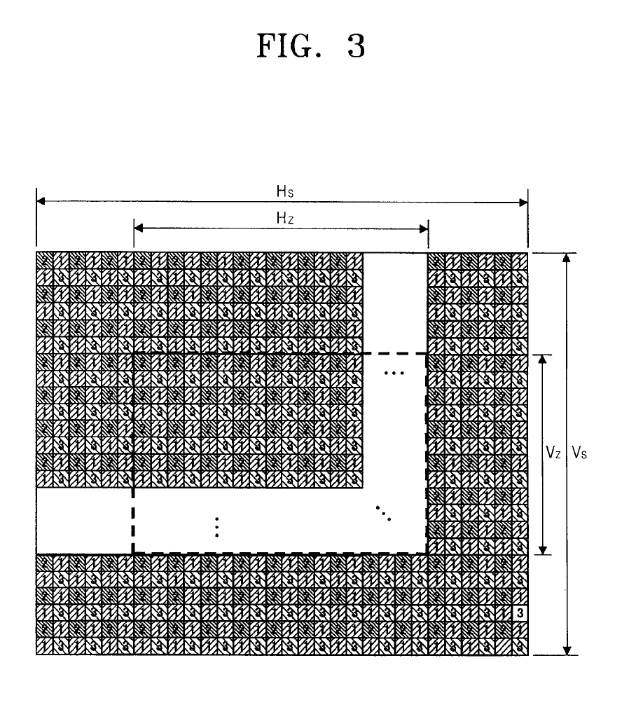

Next, an example of magnification in digital zoom will be described in reference with FIG. 3. FIG. 3 is a schematic diagram of an example of an image capturing surface of an imaging device according to an embodiment of the present invention.

Compressed image data generated by the image signal processor 120 and the size processor 122 is data on which digital zoom process is performed, and only data in the Hz×Vz region (a region of the original image) shown in FIG. 3 is extracted and recorded. Meanwhile, for raw data generated by the format processor 110, entire data from image capturing surface in the Hs×Vs region shown in FIG. 3 is recorded. Power data is not limited to power, and may be data required for magnification process (magnification information). For example, power data may include (1) combination of Hz and Vz, (2) ratio of Hs/Hz and ratio of VsNz (digital zoom ratio). Furthermore, power data may also include (3) an offset location from upper-left corner of the image capturing surface. The zoom power designator 130 outputs power data (magnification information), which includes (1) through (3), per frame. Also, an image in which a zoom effect is reflected same as digital zoom manipulation is performed can be obtained by performing image signal process on raw data by using the power data (magnification information).

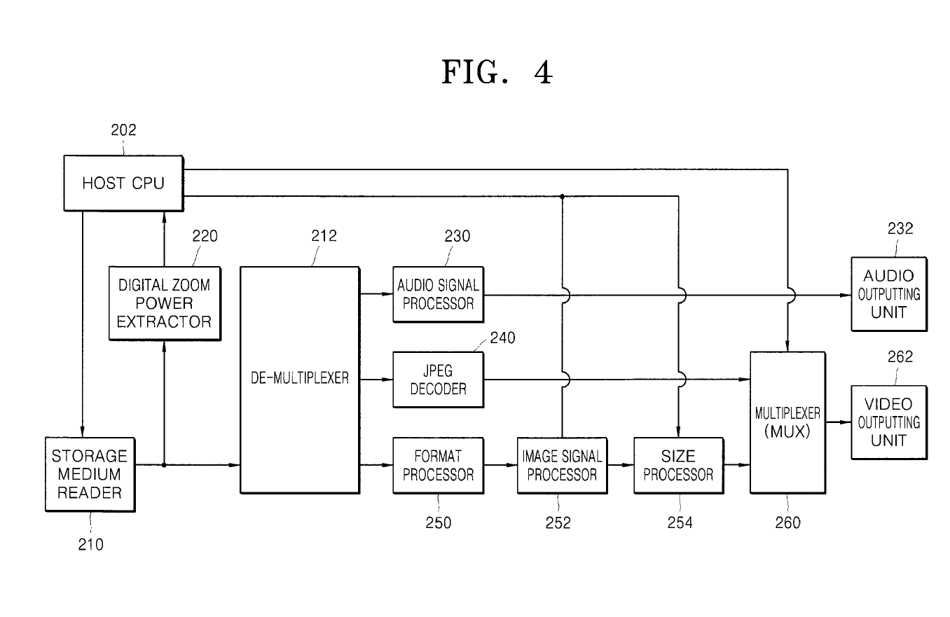

Next, an example of a motion picture reproduction apparatus 200 reproducing motion picture data recorded in the motion picture recording apparatus 100 of FIG. 1 will be described in reference with FIG. 4. FIG. 4 is a block diagram illustrating an example of a configuration of the motion picture reproduction apparatus 200 according to an embodiment of the present invention. The motion picture reproduction apparatus 200 includes a host CPU 202, a storage medium reader 210, a de-multiplexer 212, a digital zoom power extractor 220, an audio signal processor 230, an audio outputting unit 232, a JPEG decoder 240, a format processor 250, an image signal processor 252, a size processor 254, a multiplexer (MUX) 260, and a video outputting unit 262. The storage medium reader 210 reads data from a storage medium according to an instruction from the host CPU 202. The de-multiplexer 212 temporarily collects read data from the storage medium reader 210 and transmits the collected data to the audio signal processor 230, the JPEG decoder 240, and the format processor 250. The digital zoom power extractor 220 extracts power data recorded in a frame header and transmits the power data to the host CPU 202.

The host CPU 202 controls image processes such as magnification process in the image signal processor 252 or the size processor 254 according to the power data transmitted from the digital zoom power extractor 220. In a case where power data is read out from a storage medium, image signal process and sizing process are performed according to the power data. Thus, high quality image signal process and sizing process, corresponding to digital zoom manipulation when capturing an image, can be performed by image process control of the host CPU.

The audio signal processor 230 deformats audio data, converts the deformatted signals from digital to analog, and transmits the converted signals to the audio outputting unit 232. The audio outputting unit 232 outputs the analog-converted audio signals. Furthermore, the JPEG decoder 240 decodes compressed image data, reduces or magnifies the decoded image data, and transmits the image data either reduced or magnified to the multiplexer 260.

In addition, the format processor 250 performs Bayer de-formatting on raw data, rearranges the raw data in the Bayer arrangement, and transmits the rearranged raw data to the image signal processor 252. With respect to the deformatted raw data, the image signal processor 252 performs predetermined image signal processes such as white balance process, data interpolation process according to the Bayer arrangement, noise elimination, brightness and color correction, etc.

The size processor 254 performs a process reducing the size of raw data on which image signal process are performed and transmits the reduced raw data to the MUX 260. The MUX 260 transmits image data, transmitted from the JPEG decoder 240 or the size processor 254, to the video outputting unit 262. The video outputting unit 262 converts the transmitted data from digital to analog and outputs the analog-converted signal data. Furthermore, processes in the motion picture reproduction apparatus 200 can be performed either by hardware or software.

In the motion picture reproduction apparatus 200 according to this embodiment, the image signal process and sizing process are performed by using power data recorded in each of frame headers of a file read out by the storage medium reader 210. Furthermore, according to the motion picture reproduction apparatus 200 according to the current embodiment, image signal process on raw data can be performed by software, and thus high-end algorithms can be used. As a result, a magnification process according to image capturing conditions such as an image resolution or a frame rate can be performed, and thus high quality image signal process can be performed. Furthermore, although a case of using power data is described in the current embodiment, the present invention is not limited thereto, and thus the present invention can be applied to a case using magnification information other than power data.

In a case where raw data is reproduced, each of the raw data including G, B, and R are read from a storage medium. The raw data is changed to image signals by performing image signal processes on the read data. The signals are reduced to a predetermined image size and are output from the video outputting unit 262. Thus, high quality images can be reproduced by the motion picture reproduction apparatus 200.

In a case where compressed image data is reproduced, the compressed image data can be reproduced by sequentially reading compressed image data from a storage medium per frame. In this case, the size of read-out data is significantly smaller than that of raw data. By reducing or magnifying JPEG-decoded image signals into a predetermined image size and outputting the image signals either reduced or magnified, compressed image data can be reproduced with processes inflicting less load as compared to raw data reproduction. Accordingly, by using simplified reproduction mode using compressed image data, the hardware configuration of the motion picture reproduction apparatus 200 can be significantly simplified. Furthermore, power consumption can be significantly lowered.

Also, in a high-speed reproduction mode, which is a special reproduction mode, a low-load process can be performed by using JPEG data. In this case, it is required to browse only frame headers to reproduction speed, read compressed image data by performing interlaced scan on only required frames from data size information of audio data, compressed image data, and raw data, JPEG decodes the compressed image data, and read out the decoded data. The method can also be used in reverse reproduction.

Furthermore, it is also possible to show an index of captured images in a file as thumbnail images by using compressed image data. In this case, with respect to each of a plurality of motion picture files, one frame images of each motion picture files can be shown as thumbnail images or the motion picture can be shown as thumbnail images.

As described hitherto, both raw data and compressed image data can be recorded by relating them to each other according to the current embodiment. Therefore, raw data can be used for high quality reproduction, whereas compressed image data which has small size can be used for real time display, image browsing, etc. Thus, the motion picture recording apparatus 100 and the motion picture reproduction apparatus 200 providing high image quality and excellent control-base interaction can be provided. Hence, according to the embodiments of the present invention described herein, the degradation of quality of recorded image is prevented and digital zoom image with high-quality can be reproduced, having a magnification information regarding digital zoom manipulation which is performed when the image is captured.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A recording apparatus comprising:
an image processor for processing raw data sequentially output from an imaging device in frames into reproducible image data and generating processed image data in frames;
a magnification information obtaining unit for obtaining magnification information, which is information regarding a magnification process performed during the image processes; and
a storage medium recorder for sequentially recording the raw data in frames, the processed image data in frames, and the magnification information in frames to a storage medium per frame.

2. The recording apparatus of claim 1, wherein the magnification information includes power data.

3. The recording apparatus of claim 1, wherein the magnification information designates a region of an original image to be magnified.

4. A reproduction apparatus comprising:
a data reader for reading at least one of each of raw data, each of processed image data, and each of magnification information from a storage medium having recorded thereon the raw data in frames, the processed image data in frames having been obtained by performing image processes into reproducible image data on the raw data, and the magnification information regarding digital zoom manipulation performed during recording the processed image data; and
an image processor for performing an image process that partially magnifies corresponding raw data in a frame according to the read magnification information when the raw data is sequentially reproduced per frame.

5. The reproduction apparatus of claim 4, wherein the magnification information includes power data.

6. The reproduction apparatus of claim 4, wherein the magnification information designates a region of an original image to be magnified.

7. A recording method comprising:
processing raw data, sequentially output from an imaging device in frames, into reproducible image data, and generating processed image data in frames;
obtaining magnification information, which is information regarding magnification process performed during the image processes; and
sequentially recording the raw data in frames, the processed image data in frames, and the magnification information in frames to a storage medium.

8. The recording method of claim 7, wherein the magnification information includes power data.

9. The recording method of claim 7, wherein the magnification information designates a region of the original image to be magnified.

10. A reproducing method comprising:
reading at least one of each of raw data, each of processed image data, and each of magnification information from a storage medium having recorded thereon the raw data in frames, the processed image data in frames having been obtained by performing image processes into reproducible image data on the raw data, and the magnification information regarding digital zoom manipulation performed during recording the processed image data; and
performing an image process that partially magnifies corresponding raw data in a frame according to the read-out magnification information when the raw data is sequentially reproduced per frame.

11. The reproducing method of claim 10, wherein the magnification information includes power data.

12. The reproducing method of claim 10, wherein the magnification information designates a region of the original image to be magnified.

13. A storage medium having recorded thereon a computer program for executing a method, the method comprising:
processing raw data, sequentially output from an imaging device in frames, into reproducible image data, and generating processed image data in frames;
obtaining magnification information, which is information regarding magnification process performed during the image processes; and
sequentially recording the raw data in frames, the processed image data in frames, and the magnification information in frames to a storage medium.

14. The recording method of claim 13, wherein the magnification information includes power data.

15. The recording method of claim 13, wherein the magnification information designates a region of the original image to be magnified.

16. A storage medium having recorded thereon a computer program for executing a method, the method comprising:
reading out at least one of each of raw data, each of processed image data, and each of magnification information from a storage medium to which the raw data in frames, the processed image data in frames having been obtained by performing image processes into reproducible image data on the raw data, and the magnification information regarding digital zoom manipulation performed during recording the processed image data; and
performing an image process partially magnifying corresponding raw data in a frame according to the read-out magnification information when the raw data is sequentially reproduced per frame.

17. The reproducing method of claim 16, wherein the magnification information includes power data.

18. The reproducing method of claim 16, wherein the magnification information designates a region of the original image to be magnified.
